(19) United States
(12) Patent Application Publication
(10) Pub. No.: US 2024/0316535 A1
(43) Pub. Date: Sep. 26, 2024

(54) Biodegradable and Renewable Superabsorbent Material

(71) Applicant: Kimberly-Clark Worldwide, Inc., Neenah, WI (US)

(72) Inventors: Jian Qin, Appleton, WI (US); Gregory J. Wideman, Menasha, WI (US); Mark M. Mleziva, Appleton, WI (US); Feng Chen, Roswell, GA (US); David G. Biggs, New London, WI (US); Wing-Chak Ng, Roswell, GA (US)

(21) Appl. No.: 18/692,089

(22) PCT Filed: Oct. 14, 2022
(86) PCT No.: PCT/US2022/046687

§ 371 Date: Mar. 14, 2024

Related U.S. Application Data
(60) Provisional application No. 63/255,619, filed on Oct. 14, 2021.
(60) Provisional application No. 63/255,609, filed on Oct. 14, 2021.

(51) Int. Cl. B01J 20/30; B01J 20/24; B01J 20/28

(52) U.S. Cl. CPC B01J 20/3007; B01J 20/24; B01J 20/28011; B01J 20/28085; B01J 20/3078; B01J 2220/4825

(57) ABSTRACT

A biodegradable superabsorbent material is provided that has a low density and high absorbency properties. The biodegradable superabsorbent material is formed from a high-molecular weight linear water-soluble biodegradable polymer, and is formed from a polymer composition having a weight percent of solids of greater than 30 wt. %.

### BACKGROUND OF THE INVENTION

Superabsorbent materials are employed in a wide variety of applications to help absorb fluids. These materials are generally capable of absorbing a fluid (e.g., water, saline, etc.) in an amount several times their own weight. Still, one problem associated with many conventional superabsorbent materials is that when they initially come into contact with the fluid, the rate of absorption can be relatively slow, causing pre-mature leakage.

In an effort to improve the rate of absorption, phase inversion of superabsorbent materials has been proposed. Phase inversion includes swelling of the biodegradable superabsorbent material in a solvent, washing the swollen superabsorbent material in a non-solvent, and removing the non-solvent via drying. While phase inversion has yielded superabsorbent materials with very fast absorption rates, it has been found that large amounts of non-solvent (e.g. up to as much as 13%) remain in the superabsorbent material, which can ultimately decrease the absorbency under load (AUL) of the material and cause an unpleasant alcohol odor to be released from the material when used. Furthermore, even if a majority of non-solvent (e.g. an organic solvent) is removed from the resulting article, handling, removal, and/or recycling of the non-solvent is necessary.

In addition, efforts have been made to form porous aerogels or foamed materials, for example, formed from inorganic particles, silica, and the like, and crosslinking the porous aerogels or foamed materials with an acrylate monomer. However, as the porosity is due to the preexisting porosity of the aerogel or foamed material (e.g. prior to crosslinking with the precursor monomer), the resulting pores in the superabsorbent particles are unable to cure the above problems. Namely, such an approach forms large pores (such as greater than 200 μm), a low overall porosity of the particle or material (e.g. less than 5% of the material contains pores or voids), and/or pores are not interconnected, which therefor fail to provide a superabsorbent material with a rapid absorption rate. Similarly, existing pore formation methods are not reversible, meaning that once the material is wetted, the porous structure disappears if re-dried.

Moreover, each of the above attempts utilize non-biodegradable polymers. Namely, biodegradable, or renewable, polymers, such as natural based polymers including modified cellulose, contain highly ordered molecular structures that need to be homogenized in water in order to convert the highly crystalline structures to random coiled structures which can react with cross-linking agents to yield a highly absorbent material. For instance, such highly crystalline structures can be cross-linked in the crystalline state, but fail to yield the absorbency properties necessary for superabsorbent materials if not converted into random coiled structures via homogenization. However, such natural based polymers exhibit high molecular weights (and similarly, high viscosities during homogenization) which restrict the natural polymers from being homogenized at solid levels of 10 wt. % or greater which are necessary and cost efficient for producing superabsorbent particles according to existing methods. Furthermore, using existing methods, it was found that the absorbency of the material decreased when processing biodegradable polymers at solids levels of greater than 5 wt. %. Thus, so far, attempts to utilize biodegradable polymers to form superabsorbent particles have proven unsuccessful.

Therefore, it would be a benefit to provide a superabsorbent material formed from a biodegradable and/or renewable polymer. It would also be a benefit to provide a method for forming a superabsorbent material from a biodegradable and/or renewable polymer that utilizes a weight percent of solids of 30 wt. % or more while exhibiting excellent absorbent properties. It would be a further benefit to provide a superabsorbent material from a biodegradable and/or renewable polymer that exhibits an internal microporous structure and/or good absorbent rate. In addition, it would be a benefit to provide a superabsorbent material from a biodegradable and/or renewable polymer that maintains its porous structure after wetting and re-drying.

### SUMMARY OF THE INVENTION

The present disclosure is generally directed to a method for forming a biodegradable superabsorbent material. The method includes forming an aqueous polymer solution containing about 30 wt. % solids or greater, extruding or pressing the polymer solution through an orifice, drying the extruded or pressed polymer, and curing the dried polymer at a temperature above a reaction temperature of the non-reactive crosslinking agent, where, prior to the curing step, the temperature is maintained below the reaction temperature of the non-reactive crosslinking agent. Moreover, the aqueous polymer solution contains a linear water-soluble biodegradable polymer having a molecular weight of about 500,000 g/mol or greater and a non-reactive crosslinking agent.

In one aspect, at least a portion of the linear water-soluble biodegradable polymer is added to the aqueous polymer solution as a dry powder. Additionally or alternatively, the aqueous polymer solution contains about 40 wt. % solids or greater. In yet a further aspect, the aqueous polymer solution contains about 50 wt. % solids or greater. Furthermore, in an aspect, the linear water-soluble biodegradable polymer has a molecular weight of about 1,000,000 g/mol or greater, preferably about 2,000,000 or greater. In an aspect, the linear water-soluble biodegradable polymer is a natural based modified polysaccharide polymer, preferably a carboxymethyl cellulose, a carboxymethyl starch, an alginate, a chitosan salt, or combinations thereof, such as, in one aspect, a natural based modified polysaccharide polymer, preferably, in an aspect, a carboxymethyl cellulose, a carboxymethyl starch, an alginate, a chitosan salt, or combinations thereof.

In another aspect, the temperature of the method is maintained at 100° C. or less prior to curing. In one aspect, the non-reactive crosslinking agent contains two or more functional groups capable of forming a covalent bond with at least one hydrophilic radical of the linear water-soluble biodegradable polymer, preferably, in an aspect, the non-reactive crosslinking agent is glycerol, ammonium zirconium IV carbonate, or combinations thereof. Furthermore, in one aspect, the biodegradable superabsorbent material has a density of less than 1.6 g/cm³.

The present disclosure is also generally directed to a biodegradable superabsorbent material formed from a linear water-soluble biodegradable polymer having a molecular weight of about 500,000 g/mol or greater and a non-reactive crosslinking agent, where the biodegradable superabsorbent material contains a plurality of micropores having an average cross-sectional dimension of about 1 μm to about 200 μm.

In addition, the present disclosure is also generally directed to a biodegradable superabsorbent material formed from a linear water-soluble biodegradable polymer having a molecular weight of about 500,000 g/mol or greater and a non-reactive crosslinking agent, where the biodegradable superabsorbent material has a density of less than 1.6 g/cm³.

In one aspect, the linear water-soluble biodegradable polymer is a natural based modified polysaccharide polymer, preferably, in an aspect, a carboxymethyl cellulose, a carboxymethyl starch, an alginate, a chitosan salt, or combinations thereof. In an aspect, the linear water-soluble biodegradable polymer is a carboxyalkyl cellulose. In yet a further aspect, the linear water-soluble biodegradable polymer has a molecular weight of about 1,000,000 g/mol or greater, preferably, in one aspect, wherein the linear water-soluble biodegradable polymer is a carboxymethyl cellulose. In another aspect, the linear water-soluble biodegradable polymer has a molecular weight of about 2,000,000 g/mol or greater.

Additionally or alternatively, in an aspect, the non-reactive crosslinking agent contains two or more functional groups capable of forming a covalent bond with at least one hydrophilic radical of the linear water-soluble biodegradable polymer, preferably, in an aspect, the non-reactive crosslinking agent is glycerol, ammonium zirconium IV carbonate, or combinations thereof.

In one aspect, the biodegradable superabsorbent material exhibits an absorbency under load (0.3 psi) of about 15 g/g or greater. Moreover, in an aspect, the biodegradable superabsorbent material has a percent porosity of at least about 5% or more, preferably, in an aspect, at least about 10% or more. In one aspect, the biodegradable superabsorbent material is extruded, and, in an aspect, the extruded material is cut into pellets after extrusion.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 depicts an apparatus that can be used to measure absorbency under load (“AUL”) of the porous superabsorbent material of the present disclosure;

FIG. 2 shows the AUL assembly FIG. 1;

FIG. 3 is an SEM photograph of a cross sectional view of Sample 4 at 130× and 430× magnification;

FIG. 4 is a chart comparing absorbency of Sample 4 and the Control; and

FIG. 5 is an SEM photograph of the Control superabsorbent particles.

Repeat use of references characters in the present specification and drawings is intended to represent same or analogous features or elements of the invention.

### DETAILED DESCRIPTION

### Definitions

As used herein, the terms “about,” “approximately,” or “generally,” when used to modify a value, indicates that the value can be raised or lowered by 10%, such as, such as 7.5%, 5%, such as 4%, such as 3%, such as 2%, such as 1%, and remain within the disclosed aspect. Moreover, the term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example embodiments, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

As used herein, the term “biodegradable” or “biodegradable polymer” (also referred to as “renewable” and/or “natural” herein) generally refers to a material that degrades from the action of naturally occurring microorganisms, such as bacteria, fungi, archaea, and algae; environmental heat; moisture; or other environmental factors. Examples of biodegradable polymers include celluloses, starches, pectin, chitin, other polysaccharides, proteins, and derivatives thereof, such as a polyelectrolyte charged ion derivative of a natural polymer, an example of which can be a carboxyalkyl cellulose.

### DISCUSSION

Reference now will be made in detail to various embodiments of the invention, one or more examples of which are set forth below. Each example is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention covers such modifications and variations as come within the scope of the appended claims and their equivalents.

Generally speaking, the present disclosure has found that by carefully controlling the formation of a superabsorbent material, a superabsorbent material can be formed from a biodegradable polymer and still exhibit excellent absorbency properties. In addition, the present disclosure has surprisingly found that by forming a superabsorbent material according to the present disclosure, a superabsorbent material can be formed from a biodegradable polymer that exhibits a microporous structure, which, in one aspect can also be reversible, meaning that the porosity of the biodegradable superabsorbent material is maintained even after one or more uses, such as being wetted and dried by a user. Particularly, by forming a superabsorbent material with a high molecular weight linear water-soluble biodegradable polymer, instead of monomer units of the biodegradable polymer (also referred to as precursor monomer) in combination with a non-reactive crosslinking agent or latent crosslinking agent, a superabsorbent material with a high absorbent rate, and in one aspect, a large volume of micropores that can also be interconnected and/or generally homogeneously distributed, is formed a biodegradable polymer. In addition, it was surprisingly found that the polymer solution used to form the biodegradable superabsorbent material is processible, and is therefore able to be formed into one or more shapes, further increasing the surface area and absorbency of the superabsorbent biodegradable material.

For instance, in one aspect, the superabsorbent biodegradable material is formed from a combination of a high molecular weight linear water-soluble biodegradable polymer, a neutralization agent, and a non-reactive or latent crosslinking agent. Particularly, the present disclosure has surprisingly found that high-pressure processes, such as extrusion, take advantage of the highly viscous high-molecular weight biodegradable polymers, allowing such polymers to be homogenized at much higher solid weights that previously believed possible. Namely, as noted above, biodegradable polymers, and particularly high-molecular weight polymers must be homogenized in a solvent, such as water, prior to crosslinking in order to modify the crystalline structure of the polymer into a random coiled structure that can be utilized for an absorbent material. Thus, the present disclosure has surprisingly found that the method and compositions as discussed herein can surprisingly be processed at weight percent of solids that significantly higher than solids levels previously achieved.

Namely, in one aspect, the high molecular weight linear water-soluble biodegradable polymer is present in an aqueous solution at a solids content of about 20 wt. % or greater, such as about 25 wt. % or greater, such as about 30 wt. % or greater, such as about 32.5% or greater, such as about 35 wt. % or greater, such as about 37.5 wt. % or greater, such as about 40 wt. % or greater, such as about 42.5 wt. % or greater, such as about 45 wt. % or greater, such as about 47.5 wt. % or greater, such as about 50 wt. % or greater, such as about 52.5 wt. % or greater, such as about 55 wt. % or greater, such as about 57.5 wt. % or greater, such as about 60 wt. % or greater, such as about 62.5 wt. % or greater, such as even about 65 wt. % or greater, or any ranges or values therebetween.

In addition, it was surprisingly found that a biodegradable superabsorbent polymer as discussed herein even when the high molecular weight linear water-soluble biodegradable polymer has a molecular weight of about 500,000 g/mol or greater, such as about 750,000 g/mol or greater, such as about 1,000,000 g/mol or greater, such as about 1,500,000 g/mol or greater, such as about 2,000,000 g/mol or greater, such as about 2,500,000 g/mol or greater, such as about 3,000,000 g/mol or greater, such as about 3,500,000 g/mol or greater, such as about 4,000,000 g/mol or greater, or any ranges or values therebetween. Namely, as noted above, it was surprisingly found that the molecular weight of the high molecular weight linear water-soluble biodegradable polymer contributes to the viscosity of the polymer and biodegradable superabsorbent material solution, which contrary to prior methods of forming superabsorbent particles, actually contributes to improved processing utilizing high pressure formation methods, such as by trapping air or gas bubbles within the solution during extrusion, as one example.

Moreover, without intending to be limited by theory, the present disclosure has found that the non-reactive or latent crosslinking agent does not react with the high molecular weight linear water-soluble biodegradable polymer in the presence of water during extrusion (or other high pressure processes). Thus, the non-reactive or latent crosslinking agent in combination with the high molecular weight linear water-soluble biodegradable polymer are instead used to help control the viscosity of the solution. In such a manner, the molecular structure of the biodegradable superabsorbent material remains “unlocked” but viscous, allowing a biodegradable superabsorbent material to be formed from a biodegradable polymer, that can be, in an aspect, highly voided. Namely, due to the carefully controlled viscosity, a high proportion of bubbles may be trapped in the polymer solution during processing, and which are maintained at least in part by the viscosity and unique process described herein.

The present disclosure has also found that for some biodegradable polymers, an optional caustic neutralization agent which can generate gas when reacting with a high molecular weight linear water-soluble biodegradable polymer that exhibits latent absorbency properties, but that remain water-insoluble, can enhance the total volume of micropores in the biodegradable superabsorbent material (e.g., additional micropores generated by gas bubbles). Examples of such neutralization agents include neutralization agents capable of generating carbon dioxide upon reaction (e.g. neutralization) of the high molecular weight linear water-soluble biodegradable polymer. For instance, in one aspect, caustic neutralization agents capable of producing carbon dioxide include sodium carbonate, sodium bicarbonate, or combinations thereof. In one aspect, the neutralization agent needs to be pre-dissolved in a high concentration aqueous solution before the solution is mixed with dry powder of the high molecular weight linear water-soluble biodegradable polymer in order to yield the appropriate molar ratio and % neutralization. In one aspect, when solubility of a neutralization agent hits an upper limit (set by the respective solubility), a mixture of at least two neutralization agents can be used. For example, sodium carbonate generally has a low solubility (e.g. about 340 g/L at 27.8° C.) in water while sodium hydroxide has no solubility limit in water (e.g. up to about 1,000 g/L at 25° C.), therefore a mixture of a low solubility and high solubility neutralization agent can produce a neutralization solution when a concentration at or above the low solubility limit is needed. In one aspect when at least two neutralization agents are used, the neutralization agents may be used in a ratio of the low solubility neutralization agent to the high solubility agent of about 5:95 to 95:5, such as about 10:90 to 90:10, such as about 20:80 to 80:20, or any ranges or values therebetween. However, it should be understood that, in one aspect, any ratio may be used that yields a concentration according to the above ranges, or a concentration necessary to provide a % neutralization of the high molecular weight linear water-soluble biodegradable polymer discussed below. However, in one aspect, as will be discussed in greater detail below, additional dry powder high molecular weight linear water-soluble biodegradable polymer is added into a solution containing a low solid concentration of polymer, neutralization agent(s), and non-reactive or latent crosslinking agent. In such an aspect, solubility is no longer an issue in this situation, and instead, the neutralization agent can be selected based upon the amount of gas per weight generated, so that a maximum volume of air bubbles would be generated in the final product. Moreover, it should be understood that, in some aspects, biodegradable polymers are “pre-neutralized” such that no optional neutralization agent may be used. For instance, some biodegradable polymers are fully neutralized during the process that incorporates electrolyte ions into the polymer backbone, such that no additional neutralization step is available. One such example is a carboxyalkyl cellulose, where the cellulose is “neutralized” by the addition of the carboxyalkyl groups.

Nonetheless, the biodegradable superabsorbent material according to the present disclosure is porous in nature even without any optional neutralization agent and generally possess a porous network, which may contain a combination of closed and open-celled pores. Namely, without wishing to be bound by theory, it is believed that air bubbles are formed in the composition from the high molecular weight pre-polymerized polymer. In addition, further air bubbles can be created by adding additional polymer in the form of a dry powder, which will be discussed in greater detail below. Nonetheless, after formation of the air bubbles in the composition, high-pressure processes, such as extrusion, allows the air bubbles to be minimized (or reduced) in size while maintaining the air bubbles in the high-viscosity material, thus producing a highly micro-porous structure. Notably, as discussed above, it was found that the present disclosure allows formation of a superabsorbent material having a high-proportion of open-celled pores, which can be illustrated by the surface to volume ratio, which will be discussed in greater detail below. The percent porosity may also be about 5% or more, such as about 7.5% or more, such as about 10% or more, such as about 15% or more, such as about 20% or more, such as about 25% or more, such as about 30% or more, such as about 35% or more, such as about 40% or more, such as about 45% or more, such as up to about 75% or less, in some embodiments from about 10% to about 70%, and in some embodiments, from about 15% to about 65%. Furthermore, as noted above, the open-celled pores yield a porous material where at least a portion of the micropores are interconnected. For instance, in one aspect, interconnected or open-celled pores can account for about 10% to about 99.9% of the total pore volume of the superabsorbent material, such as about 20% to about 99.5%, such as about 30% to about 99%, such as about 40% to about 98%, such as about 50% to about 97%, such as about 60% to about 95%, such as about 70% to about 92.5%, such as about 80% to about 90%, or any ranges or values therebetween. Thus, the total porosity of the biodegradable superabsorbent material may be relatively high, as will be discussed in greater detail below, as a large proportion of the pores are open-celled.

The average percent volume occupied by the micropores within a given unit volume of the material may also be about 7.5% or more per cm³, such as about 10% or more per cm³, such as about 12.5% or more per cm³, such as about 15% or more per cm³, such as about 17.5% or more per cm³, such as about 20% or more per cm³, such as about 25% or more per cm³, such as about 30% or more per cm³, up to about 75% per cm³, or such as from about 5% to about 70% per cm³, in some embodiments from about 7.5% to about 67.5%, and in some embodiments, from about 10% to about 65% per cubic centimeter of the superabsorbent material. The biodegradable superabsorbent material may also contain nanopores having a size of less than 1 μm, however, as will be discussed below, micropores generally represent the majority of pores present in the superabsorbent material. The micropores may have any regular or irregular shape, such as spherical, elongated, etc.

Another parameter that is characteristic of porosity is bulk density. In this regard, the bulk density of the biodegradable superabsorbent material of the present invention is significantly lower than previous biodegradable superabsorbent materials, such as less than about 1.6 grams per cubic centimeter (g/cm³), such as about 1.5 g/cm³ or less, such as about 1.4 g/cm³, such as about 1.3 g/cm³, or less, such as about 1.2 g/cm³ or less, such as about 1.1 g/cm³ or less, such as about 1 g/cm³ or less, or such as about 0.2 g/cm³ or more, or any ranges or values therebetween as determined at a pressure of 0.58 psi via mercury intrusion.

To achieve the desired pore properties, the porous network typically contains a plurality of micropores having an average cross-sectional dimension (e.g., width or diameter) of from about 1 μm to about 200 μm, in some aspects from about 5 μm to about 175 μm, and in some aspects, from about 30 to about 150 μm. The term “cross-sectional dimension” generally refers to a characteristic dimension (e.g., width or diameter) of a pore, which is substantially orthogonal to its major axis (e.g., length). Furthermore, as discussed above, micropores can be present in a relatively high amount in the network. For example, the micropores may constitute at least about 25 vol. %, such as at least about 40 vol. %, such as up to about 99.9%, and in some aspects, from about 40 vol. % to 80 vol. % of the total pore volume of the superabsorbent material. Namely, as discussed above, the present disclosure has found that the careful formation according to the present disclosure can yield a superabsorbent material with a very high proportion of micropores within the above ranges. For instance, it should be understood that, in one aspect, substantially all of the micropores have a size according to the above cross-sectional dimension.

Based at least in part on the unique porous structure, and as will be discussed in greater detail below, the biodegradable superabsorbent material can exhibit an internal surface to volume ratio of at least 7.5 or greater, such as about 10 or greater, such as about 12.5 or greater, such as about 15 or greater, such as about 17.5 or greater, such as about 20 or greater, such as about 50 or greater, such as about 100 or greater, such as up to about 500 or less, such as about 475 or less, such as up to about 465 or less, or any ranges or values therebetween. As used herein, the internal surface is measured as a surface area of the porous interior of the biodegradable superabsorbent material, and does not refer to an external (e.g., outward facing) surface of the superabsorbent material, and the volume is the volume occupied by the material measured, which, in one aspect, may be a particle or cut piece of extrudate.

As noted above, surprisingly, the present inventors have discovered that the resulting biodegradable superabsorbent material can exhibit an enhanced rate of absorption during the specific time period in which they begin to contact a fluid, such as water, aqueous solutions of a salt (e.g., sodium chloride), bodily fluids (e.g., urine, blood, etc.), and so forth, even though the superabsorbent materials are formed from a biodegradable polymer. This increased rate can be characterized in a variety of ways. For example, the biodegradable superabsorbent material may exhibit a low Vortex Time, which refers to the amount of time in seconds required for an amount of the biodegradable superabsorbent material to close a vortex created by stirring an amount of 0.9 percent (%) by weight sodium chloride solution according to the test described below. More particularly, the biodegradable superabsorbent material may exhibit a Vortex Time of about 80 seconds or less, in some embodiments about 60 seconds or less, in some embodiments about 40 seconds or less, in some embodiments about 35 seconds or less, in some embodiments about 30 seconds or less, in some embodiments about 20 seconds or less, and in some embodiments, from about 0.1 to about 15 seconds. Alternatively, after being placed into contact with an aqueous solution of sodium chloride (0.9 wt. %) for 0.015 kiloseconds (“ks”), the Absorption Rate of the biodegradable superabsorbent material may be about 300 g/g/ks or more, in some embodiments about 400 g/g/ks or more, in some embodiments about 500 g/g/ks or more, and in some embodiments, from about 600 to about 1,500 g/g/ks. High Absorption Rates may even be retained for a relatively long period of time. For example, after being placed into contact with an aqueous solution of sodium chloride (0.9 wt. %) for 0.06 ks or even up to 0.12 ks, the Absorption Rate of the biodegradable superabsorbent material may still be about 160 g/g/ks or more, in some embodiments about 180 g/g/ks or more, in some embodiments about 200 g/g/ks or more, and in some embodiments, from about 250 to about 1,200 g/g/ks.

Notably, the increased rate of absorption can be maintained without sacrificing the total absorbent capacity of the biodegradable superabsorbent material. For example, after 3.6 ks, the total Absorbent Capacity of the biodegradable superabsorbent material may be about 10 g/g or more, in some embodiments about 15 g/g or more, such as about 20 g/g or more, such as about 25 g/g or more, such as about 30 g/g or more, and in some aspects, from about 20 to about 100 g/g. Likewise, the biodegradable superabsorbent material may exhibit a Centrifuge Retention Capacity (“CRC”) of about 20 grams liquid per gram of superabsorbent particles (g/g) or more, in some embodiments about 25 g/g or more, and in some embodiments, from about 30 to about 60 g/g. Finally, the biodegradable superabsorbent material may also exhibit a free swell gel bed permeability (“GBP”) of about 40 darcies or less, in some embodiments about 25 darcies or less, and in some embodiments, from about 0.1 to about 10 darcies.

Furthermore, in an aspect, the biodegradable superabsorbent material can be in the form of superabsorbent particles, and can have a median size (e.g., diameter) of from about 50 to about 2,000 micrometers, in some embodiments from about 100 to about 1,000 micrometers, and in some embodiments, from about 200 to about 700 micrometers. The term “median” size as used herein refers to the “D50” size distribution of the particles, which means that at least 50% of the particles have the size indicated. The particles may likewise have a D90 size distribution (at least 90% of the particles have the size indicated) within the ranges noted above. The diameter of particles may be determined using known techniques, such as ultracentrifuge, laser diffraction, etc. For example, particle size distribution can be determined according to a standard testing method such as ISO 13320:2009. The particles may also possess any desired shape, such as flake, nodular, spherical, tube, etc. The size of the particles may be controlled to optimize performance for a particular application. Of course, as will be discussed in greater detail below, the biodegradable superabsorbent material may also be in the form of fibers, fiber particles, and the like, and in one aspect, superabsorbent particles may be formed from cutting one or more extruded strands along the machine direction (e.g. reducing the length in the machine direction), which may also be referred to as superabsorbent pellets.

The specific surface area of the biodegradable superabsorbent material may also be relatively large, such as about 0.2 square meters per gram (m²/g) or more, in some embodiments about 0.6 m²/g or more, and in some embodiments, from about 1 m²/g to about 5 m²/g, such as determined in accordance with the B.E.T. test method as described in ISO 9277:2010.

The biodegradable superabsorbent material is generally formed from a three-dimensional crosslinked polymer network that contains the high molecular weight linear water-soluble biodegradable polymer and a non-reactive crosslinking agent. However, as discussed above, the crosslinking agent is non-reactive meaning that the crosslinking agent does not interact with the high molecular weight linear water-soluble biodegradable polymer during extrusion. For example, reactive crosslinking agents as defined herein contain at least two unsaturated double bonds which crosslink with absorbent monomer units during polymerization. Conversely, the non-reactive crosslinking agents used herein are not reactive crosslinking agents, and are instead a latent and/or transitional crosslinking agent that is capable of becoming crosslinked when desired. Latent and/or transitional crosslinking agents are not reactive in the polymerization step of the superabsorbent manufacturing process or extrusion/drying step of the high molecular weight linear water-soluble biodegradable polymer, but are reactive during a heat curing step after the polymer is shaped and a proper external condition is applied, such as heat, light, radiation, humidity, pressure, etc. Through the application of heat, for example, the latent crosslinking agent is activated and crosslinks the pre-polymerized polymer making it insoluble in water, providing superabsorbent properties due to the 3-D structure.

Suitable non-reactive crosslinking agents according to the present disclosure include compounds containing two or more functional groups capable of forming a covalent bond with the at least one hydrophilic radical of the high molecular weight linear water-soluble biodegradable polymer, such as any carboxyl, carboxylic acid, amino, or hydroxyl groups on the polymer backbone. Examples of non-reactive crosslinking agent functional groups include hydroxyl groups, amino groups, carboxylic acid groups, glycols, or a combination thereof. For example, non-reactive crosslinking agents include diamines, polyamines, diols, polyols, dicarboxylic acids, polycarboxylic acids, polyoxides, a metal ion with more than two positive charges, such as Al3+, Fe3+, Ce3+, Ce4+, Ti4+, Zr4+, and Cr3+, a polyanionic material such as sodium polyacrylate, carboxymethyl cellulose, or polyphosphate, or combinations thereof. For instance, in one aspect, the non-reactive crosslinking agent is glycerol, ammonium zirconium IV carbonate, or combinations thereof.

Regardless of the crosslinking agent selected, the non-reactive crosslinking agent is present in the biodegradable superabsorbent material in an amount of about 0.5% to about 12.5%, such as about 0.75% to about 10%, such as about 0.9% to about 10%, such as about 1% to about 5% by weight, based upon the weight of the high molecular weight linear water-soluble biodegradable polymer, or any ranges or values therebetween.

Nonetheless, in one aspect, the high molecular weight linear water-soluble biodegradable polymer can contain at least one hydrophilic radical, such as a carboxyl, including carboxyalkyl, carboxylic acid anhydride, carboxylic acid salt, sulfonic acid, sulfonic acid salt, hydroxyl, or a combination thereof. Particular examples of suitable pre-polymers that can be synthesized from linear biodegradable monomers to form the high molecular weight linear water-soluble biodegradable polymer for forming the biodegradable superabsorbent material include, for instance, carboxylic acids (e.g., (meth)acrylic acid (encompasses acrylic acid and/or methacrylic acid), maleic acid, fumaric acid, crotonic acid, sorbic acid, itaconic acid, cinnamic acid, etc.); carboxylic acid anhydrides (e.g., maleic anhydride); biopolymers, and so forth, as well as combinations of any of the foregoing. In one aspect, the high molecular weight linear water-soluble biodegradable polymer is a natural based modified polysaccharide polymers such as carboxymethyl cellulose, carboxymethyl starch, alginates, chitosan salt, or combinations thereof. In one aspect, the high molecular weight linear water-soluble biodegradable polymer is a polyacrylic acid polymer, a biodegradable polymer, or a combination thereof, and, in one aspect, the high molecular weight linear water-soluble biodegradable polymer is a carboxyalkyl cellulose, such as carboxymethyl cellulose.

The biodegradable superabsorbent polymer material of the present disclosure may be prepared by any known polymerization method. In some aspects, the polymers are derived from naturally occurring polymers such as polysaccharides and proteins. Additionally, or alternatively, biodegradable polymers can also be obtained from biosynthesis methods utilizing living organisms or via condensation reactions of a biodegradable monomer. However, regardless of the polymer and/or polymerization method selected, the high molecular weight linear water-soluble biodegradable polymer of the present disclosure is incorporated into the biodegradable superabsorbent material in pre-polymerized form (and is therefore not polymerized in the presence of the neutralization agent and/or the non-reactive crosslinking agent).

Moreover, in addition to the high molecular weight biodegradable absorbent polymer, the weight percentage of total solids in the polymer solution used to form the biodegradable superabsorbent material (aqueous solution containing the high molecular weight linear water-soluble biodegradable polymer, neutralization agent, non-reactive crosslinking agent, and any optional components discussed below), can also contribute to the viscosity and stability of the superabsorbent material. For instance, in one aspect, the polymer solution is an aqueous solution have a total solids content of about 20 wt. % or greater, such as about 25 wt. % or greater, such as about 30 wt. % or greater, such as about 32.5% or greater, such as about 35 wt. % or greater, such as about 37.5 wt. % or greater, such as about 40 wt. % or greater, such as about 42.5 wt. % or greater, such as about 45 wt. % or greater, such as about 47.5 wt. % or greater, such as about 50 wt. % or greater, such as about 52.5 wt. % or greater, such as about 55 wt. % or greater, such as about 57.5 wt. % or greater, such as about 60 wt. % or greater, such as about 62.5 wt. % or greater, such as even about 65 wt. % or greater, or any ranges or values therebetween.

Particularly, while several factors contribute to the viscosity and stability of the polymer solution, which will be discussed in greater detail below, in one aspect, the molecular weight and percent solids of the polymer solution are carefully selected such that the polymer solution has a viscosity of about 50 Pa*s or greater at a shear rate of 100 s⁻¹, such as about 75 Pa*s or greater at a shear rate of 100 s⁻¹, such as about 100 Pa*s or greater at a shear rate of 100 s⁻¹, such as about 125 Pa*s or greater at a shear rate of 100 s⁻¹, such as about 150 Pa*s or greater at a shear rate of 100 s⁻¹, such as about 175 Pa*s or greater at a shear rate of 100 s⁻¹, such as about 200 Pas or greater at a shear rate of 100 s⁻¹, such as about 250 Pa*s or greater at a shear rate of 100 s⁻¹, such as about 300 Pa*s or greater at a shear rate of 100 s⁻¹, such as about 400 Pas or greater at a shear rate of 100 s⁻¹ such as about 450 Pa*s or greater at a shear rate of 100 s⁻¹, such as about 500 Pa*s or greater at a shear rate of 100 s⁻¹, such as about 1,000 Pas or greater at a shear rate of 100 s⁻¹, such as about 5,000 Pa*s or greater at a shear rate of 100 s⁻¹, such as about 6,500 Pa*s or greater at a shear rate of 100 s⁻¹, up to about 25,000 Pa*s at a shear rate of 100 s⁻¹, and/or exhibits a viscosity of about 6,000 Pa*s or greater at a shear rate of 0.5 s⁻¹, such as about 10,000 Pa*s or greater at a shear rate of 0.5 s⁻¹, such as about 25,000 Pa*s or greater at a shear rate of 0.5 s⁻¹, such as about 40,000 Pa*s or greater at a shear rate of 0.5 s⁻¹, such as about 50,000 Pas or greater at a shear rate of 0.5 s⁻¹, such as about 100,000 Pa*s or greater at a shear rate of 0.5 s⁻¹, such as about 250,000 Pa*s or greater at a shear rate of 0.5 s⁻¹, such as about 500,000 Pa*s or greater at a shear rate of 0.5 s⁻¹, up to about 2,000,000 Pas at a shear rate of 0.5 s⁻¹, or any ranges or values therebetween. Namely, as will be discussed in greater detail below, viscosity of the polymer solution was found to contribute to high porosity and homogeneous distribution of micropores throughout the superabsorbent material.

Furthermore, due to the unique combination of viscous polymer solution and latent/transition crosslinking agent, the present disclosure has further found that absorbency and uptake of the biodegradable superabsorbent material can be further improved by shaping the biodegradable superabsorbent material via one or more high pressure processes. For instance, as may be understood in the art, crosslinked superabsorbent materials cannot be extruded, or subjected to other high pressure shape-altering processes due to the crosslinking present in the material (e.g. crosslinked prior to extrusion in the presence of water). Furthermore, existing biodegradable superabsorbent materials utilize polymer solutions of about 10 wt. % solids or less, alone or in combination with a heated process, in order to improve processability. However, such a low solids content alone or in combination with heat lowers the viscosity of the polymer solution to a point where the polymer solution will not hold its shape or retain air bubbles generated during extrusion step if extruded or otherwise processed at high pressures. Conversely, the present disclosure has found that the unique polymer composition allows thermoplastic-like processes due at least in part to the high molecular weight, high solids and/or viscosity of the biodegradable polymer and the delayed crosslinking due to use of a biodegradable polymer instead of a crosslinked prepolymer. Thus, in one aspect, the biodegradable superabsorbent material of the present disclosure can be extruded, injection molded, compression molded, fiber spun, pressure coated, or the like, or combinations thereof, while maintaining its shape and porosity during drying. Nonetheless, in one aspect, the superabsorbent article is extruded.

Furthermore, the unique properties and combination of the present disclosure allow an extruded superabsorbent material to be formed that maintains its shape and porosity while drying and prior to curing/crosslinking, which allows intricate cross-sectional shapes to be formed. Thus, in one aspect, these cross sectional shapes allow the biodegradable superabsorbent material to exhibit an improved external surface area, such as to exhibit a ratio of external surface area to volume of superabsorbent article of about 3.2 or greater, such as about 3.5 or greater, such as about 4 or greater, such as about 4.5 or greater, such as about 5 or greater, such as about 5.5 or greater, such as about 6 or greater, such as about 6.5 or greater, such as about 7 or greater, or any ranges or values therebetween. To differentiate from the internal surface to volume discussed above, it should be understood that the external surface area is not the surface area of the porous interior, and is instead an external surface area of the material. Exemplary cross-sections can include any shape, such as a flower, crown, star, snowflake and the like, as long as the cross section maintains a ratio of external surface area according to the above. In addition, it should be clear that the biodegradable superabsorbent material according to the present disclosure may have an internal or external ratio, or both an internal and external ratio according to the present disclosure. Namely, the porosity and external patterning may co-exist in one aspect, or be present in separate aspects.

If desired, the resulting material may also be downsized to achieve the desired size noted above. For instance, impact downsizing, which typically employs a grinder having a rotating grinding element, may be used to form the superabsorbent material. Repeated impact and/or shear stress can be created between the rotating grinding element and a stationary or counter-rotating grinding element. Impact downsizing may also employ air flow to carry and collide the material into a grinding disk (or another shearing element). One particularly suitable impact downsizing apparatus is available commercially from Pallmann Industries (Clifton, N.J.) under the name Turbofiner®, type PLM. In this apparatus, a high activity air whirl is created within a cylindrical grinding chamber between a stationary grinding element and a rotating grinding element of an impact grinding mill. Due to the high air volume, the biodegradable superabsorbent material can be impacted and become downsized into the desired particle size. Other suitable impact downsizing processes may be described in U.S. Pat. Nos. 6,431,477 and 7,510,133, both to Pallmann. Another suitable microparticle formation process is cold extrusion downsizing, which generally employs shear and compression forces to form particles having the desired size. For example, the material can be forced through a die at temperatures below the freezing point of the polymer solution. Solid-state shear pulverization is another suitable process that can be used. Such processes generally involve continuous extrusion of the material under high shear and compression conditions while the extruder barrels and a screw are cooled to prevent polymer melting. Examples of such solid state pulverization techniques are described, for instance, in U.S. Pat. No. 5,814,673 to Khait; U.S. Pat. No. 6,479,003 to Furgiuele, et al.; U.S. Pat. No. 6,494,390 to Khait, et al.; U.S. Pat. No. 6,818,173 to Khait; and U.S. Publication No. 2006/0178465 to Torkelson, et al. Yet another suitable microparticle formation technique is known as cryogenic disk milling. Cryogenic disk milling generally employs a liquid (e.g., liquid nitrogen) to cool or freeze the material prior to and/or during grinding. In one embodiment, a single-runner disk milling apparatus can be employed that has a stationary disk and a rotating disk. The material enters between the discs via a channel near the disk center and is formed into particles through the frictional forces created between the discs. One suitable cryogenic disk milling apparatus is available under the name Wedco® cryogenic grinding system from ICO Polymers (Allentown, PA). However, in one aspect, the polymer solution may be cut as it exits the extruder with the cutting speed set based upon the desired machine-direction length.

Although by no means required, additional components may also be combined with the biodegradable superabsorbent polymer, before, during, or after polymerization. In one embodiment, for instance, high aspect ratio inclusions (e.g., fibers, tubes, platelets, wires, etc.) may be employed to help produce an internal interlocking reinforcing framework that stabilizes the swelling biodegradable superabsorbent polymer and improves its resiliency. The aspect ratio (average length divided by median width) to may, for instance, ranges from about 1 to about 50, in some embodiments from about 2 to about 20, and in some embodiments, from about 4 to about 15. Such inclusions may have a median width (e.g., diameter) of from about 1 to about 35 micrometers, in some embodiments from about 2 to about 20 micrometers, in some embodiments from about 3 to about 15 micrometers, and in some embodiments, from about 7 to about 12 micrometers, as well as a volume average length of from about 1 to about 200 micrometers, in some embodiments from about 2 to about 150 micrometers, in some embodiments from about 5 to about 100 micrometers, and in some embodiments, from about 10 to about 50 micrometers. Examples of such high aspect inclusions may include high aspect ratio fibers (also known as “whiskers”) that are derived from carbides (e.g., silicon carbide), silicates (e.g., wollastonite), etc.

If desired, a hydrophobic substance may also be combined with the biodegradable superabsorbent polymer, such as a substance containing a hydrocarbon group, a substance containing a hydrocarbon group having a fluorine atom, a substance having a polysiloxane structure, etc. Examples of such substances as well as superabsorbent particles formed therefrom are described, for instance, in U.S. Pat. No. 8,742,023 to Fujimura, et al., which is incorporated herein in its entirety by reference thereto. For instance, suitable hydrophobic substances may include polyolefin resins, polystyrene resins, waxes, long-chain fatty acid esters, long-chain fatty acids and salts thereof, long-chain aliphatic alcohols, long-chain aliphatic amides, etc., as well as mixtures thereof. In one particular embodiment, a long-chain fatty acid ester may be employed that is an ester of a fatty acid having 8 to 30 carbon atoms and an alcohol having 1 to 12 carbon atoms, such as methyl laurate, ethyl laurate, methyl stearate, ethyl stearate, methyl oleate, ethyl oleate, glycerol monolaurate, glycerol monostearate, glycerol monooleate, pentaerythritol monolaurate, pentaerythritol monostearate, pentaerythritol monooleate, sorbitol monolaurate, sorbitol monostearate, sorbitol monooleate, sucrose monopalmitate, sucrose dipalmitate, sucrose tripalmitate, sucrose monostearate, sucrose distearate, sucrose tristearate, tallow, etc. In another embodiment, a long-chain fatty acid or a salt thereof may be employed that contains 8 to 30 carbon atoms, such as lauric acid, palmitic acid, stearic acid, oleic acid, dimer acid, behenic acid, etc., as well as zinc, calcium, magnesium, and/or aluminum salts thereof, such as calcium palmitate, aluminum palmitate, calcium stearate, magnesium stearate, aluminum stearate, etc.

Regardless of the specific manner in which the biodegradable superabsorbent material is formed, a variety of different techniques may also be employed in which a porous network is formed within the superabsorbent material. For instance, in one aspect, the high molecular weight linear water-soluble biodegradable polymer is incorporated into the polymer solution as a dry powder. In such an aspect, mixing of the high molecular weight linear water-soluble biodegradable polymer incorporates air bubbles into the high-viscosity polymer solution sufficient to yield the porous structure of the present disclosure. Alternatively, a gas, such as CO₂, N₂, Ar₂, air, or combinations thereof may be bubbled into the polymer solution. Alternatively, a foaming agent may be incorporated into the polymer solution. However, it should be understood that the foaming agent is selected to be stable until the curing stage, namely, that the foaming agent is activated by the conditions utilized to cure the composition after drying. Nonetheless, as discussed above, it should be understood that the unique properties of the biodegradable superabsorbent polymer allow the bubbles to be stabilized in the polymer solution during processing and drying.

In one aspect, the neutralization agent may also be a foaming/gas providing agent, such as sodium carbonate. However it should be understood that any basic compound may be used, including sodium hydroxide, potassium hydroxide, combinations thereof, or the like. Regardless of the neutralization agent selected, the neutralization agent should be present in an amount sufficient to yield a degree of neutralization of the high molecular weight linear water-soluble biodegradable polymer of about 50% or more, such as about 52.5% or more, such as about 55% or more, such as about 57.5% or more, such as about 60% or more, such as about 62.5% or more, such as bout 65% or more, such as about 67.5% or more, such as about 70%, or any ranges or values therebetween.

After extrusion, the liquid phase may be dried and/or removed using any suitable technique, such as by increased temperature, time, vacuum, and/or flow rate control using any suitable equipment (e.g., forced air ovens and vacuum ovens). However, in one aspect, the present disclosure has found that by drying at low temperatures, more evenly distributed micropores according to the above ranges may be formed. Without intending to be limited by theory, it is theorized that high temperature drying may decrease the viscosity of the polymer solution and/or cause any gas present to expand, reducing the number of pores and/or forming few large pores. Thus, in one example, for instance, the biodegradable superabsorbent material is subjected to low temperature drying at temperatures of about 100° C. or less, such as about 90° C. or less, such as about 80° C. or less, such as about 70° C. or less, such as about 60° C. or less, such as about 50° C. or less, such as about 40° C. or less, or such as at room temperature, for a time sufficient to reach a target moisture level of about 1 wt. % to about 12.5 wt. %, such as about 1.5 wt. % to about 11 wt. %, such as about 2 wt. % to about 10 wt. %, or any ranges or values therebetween.

Furthermore, in one aspect, the biodegradable superabsorbent material can be subjected to surface crosslinking treatment with a surface crosslinking agent. The surface crosslinking treatment can make the gel strength of the biodegradable superabsorbent material high and improve the balance of CRC and GBP. As surface crosslinking agents, any conventional surface crosslinking agents (polyvalent glycidyls, polyvalent alcohols, polyvalent amines, polyvalent aziridines, polyvalent isocyanates, silane coupling agent, alkylene carbonate, polyvalent metals, etc.) can be used if incorporated into the biodegradable superabsorbent material after extrusion and drying. Among these surface crosslinking agents, with consideration given to economic efficiency and absorption characteristics, the surface crosslinking agent is preferably a polyvalent glycidyl, a polyvalent alcohol, or a polyvalent amine. The surface crosslinking agents can be used singly or as a mixture of two or more kinds thereof.

Where the surface crosslinking treatment is performed, the amount (% by weight) of the surface crosslinking agent used is not particularly limited because the amount can be varied depending on the kind of the surface crosslinking agent, conditions for crosslinking, target performance, and the like. Considering absorption characteristics, the amount is preferably from 0.001 to 3% by weight, more preferably from 0.005 to 2% by weight, and particularly preferably from 0.01 to 1% by weight based on the weight of the superabsorbent particle.

The surface crosslinking treatment is performed by mixing the biodegradable superabsorbent material with the surface crosslinking agent or agents, followed by heating. Suitable processes are described in more detail in Japanese Patent No. 3648553, JP-A-2003-165883, JP-A-2005-75982, and JP-A-2005-95759, each of which is incorporated herein by reference to the extent it does not conflict herewith. Mixing the biodegradable superabsorbent polymer with the surface crosslinking agent can be done using any suitable equipment including any conventional equipment (cylinder type mixer, screw type mixer, screw type extruder, turbulizer, Nauta mixer, kneader mixer, flow type mixer, V-shape mixer, mincing machine, ribbon mixer, air flow type mixer, disc type mixer, conical blender, rolling mixer). The surface crosslinking agent can be diluted by water and/or solvents.

Regardless of whether an optional surface crosslinking agent is used, the dried superabsorbent material, the non-reactive crosslinking agent, and the optional surface crosslinking agent are subjected to a crosslinking temperature of about 100 to about 200° C., such as about 140 to about 190° C., such as about 150 to about 180° C., or any ranges or values therebetween. The heating time for crosslinking can be appropriately controlled based on the temperature. From the viewpoint of the absorbing performance, the time for surface and/or non-reactive cross linking is preferably 5 to 60 minutes, and more preferably 10 to 40 minutes.

Nonetheless, as may be understood from the above description, the present disclosure is also generally directed to a method of forming a biodegradable superabsorbent material. Particularly, as discussed above, the present disclosure has found that by starting with a high molecular weight linear water-soluble biodegradable polymer, instead of monomer or precursor units, a biodegradable superabsorbent material can be formed utilizing high weight percent solids and without the need for aerogels or organic solvents. Thus, in one aspect, a high molecular weight linear water-soluble polymer is placed into an extruder or pressurized system along with an aqueous solution containing the non-reactive crosslinking agent and neutralizing agent. The high molecular weight linear water-soluble biodegradable polymer is added to the solution until a percent solids is obtained according to the above ranges. The polymer solution is then mixed with any optional components, and extruded or pressurized through one or more dies. Furthermore, as discussed, the extrusion should be conducted at low temperatures, such as less than 50° C., or at room temperature. In addition, as will be discussed in greater detail below, in one aspect, a polymer solution containing the high molecular weight linear water-soluble biodegradable polymer may be formed, and additional high molecular weight linear water-soluble biodegradable polymer, that can be the same or different from the high molecular weight linear water-soluble biodegradable polymer in solution, in the form of a dry powder can be added if needed to increase the solids level of the polymer solution to the above ranges.

As discussed above, the one or more dies can generally have any cross-section as known in the art. However, in one aspect, a die is selected that defines one or more shapes that exhibit a ratio of external surface area to volume of about 3.2 or greater, such as about 3.5 or greater, such as about 4 or greater, such as about 4.5 or greater, such as about 5 or greater, such as about 5.5 or greater, such as about 6 or greater, such as about 6.5 or greater, such as about 7 or greater, or any ranges or values therebetween. Namely, it should be understood that the external surface area relates to a surface area formed by an outer edge of the die, whereas the cross sectional area has its standard meaning in the art. Exemplary cross-sections can include any shape, such as a flower, crown, star, snowflake and the like, as long as the cross section maintains a ratio of external surface area according to the above.

Nonetheless, after extrusion, the biodegradable superabsorbent material is allowed to dry at the low temperatures as discussed above, subjected to optional surface crosslinking, and then cured/reacted at the above discussed temperatures above the reaction temperature of the non-reactive crosslinking agent to form a superabsorbent material according to the present disclosure.

In addition, either prior to drying, or after drying, the extruded polymer solution may be cut into pellets by cutting the extrudate along the machine direction, as desired based upon the end use of the superabsorbent material.

Furthermore, the biodegradable superabsorbent material discussed herein is suitable for use in any existing products where superabsorbency is desired. For instance, as the biodegradable superabsorbent material contains substantially no organic solvent, the biodegradable superabsorbent material is well suited for food-contacting or user-contacting applications, include grocery packaging and garments, to name a few.

The present invention may be better understood with reference to the following examples.

### Test Methods

### Pore Properties

The pore properties (e.g., average pore diameter, total pore area, bulk density, pore size distribution, and percent porosity) of superabsorbent material may be determined using mercury porosimetry (also known as mercury intrusion) as is well known in the art. For example, a commercially available porosiometer, such as AutoPore IV 9500 from Micrometrics, may be employed. Such devices generally characterize porosity by applying various levels of pressure to a sample immersed in mercury. The pressure required to intrude mercury into the sample's pores is inversely proportional to the size of the pores. Measurements may be performed at an initial pressure of 0.58 psi and at a final pressure of about 60,000 psi. The average pore diameter, total pore area, and bulk density may be directly measured during the mercury intrusion test. The overall pore size distribution may be derived from a graph of differential intrusion and pore diameter (μm). Likewise, the percent porosity may be calculated based on the reduction in bulk density reduction (assuming a constant size, packing, and shape of the material) taking into consideration that approximately 50% of volume is occupied by empty space due to material packing. More particularly, the percent porosity may be determined according to the following equation:

$$100 \times 0.5 \times [ ( Bulk Density of Control Sample - Bulk Density of Test Sample ) / Bulk Density of Control Sample ]$$

wherein the Bulk Density (g/cm³) is determined by mercury intrusion at a pressure of 0.58 psi.

### Absorbent Capacity

The absorbent capacity of superabsorbent material can be measured using an Absorbency Under Load (“AUL”) test, which is a well-known test for measuring the ability of superabsorbent material to absorb a 0.9 wt. % solution of sodium chloride in distilled water at room temperature (test solution) while the material is under a load. For example, 0.16 grams of superabsorbent material may be confined within a 5.07 cm² area of an Absorbency Under Load (“AUL”) cylinder under a nominal pressure of 0.01 psi, 0.3 psi, or 0.9 psi. The sample is allowed to absorb the test solution from a dish containing excess fluid. At predetermined time intervals, a sample is weighed after a vacuum apparatus has removed any excess interstitial fluid within the cylinder. This weight versus time data is then used to determine the Absorption Rates at various time intervals.

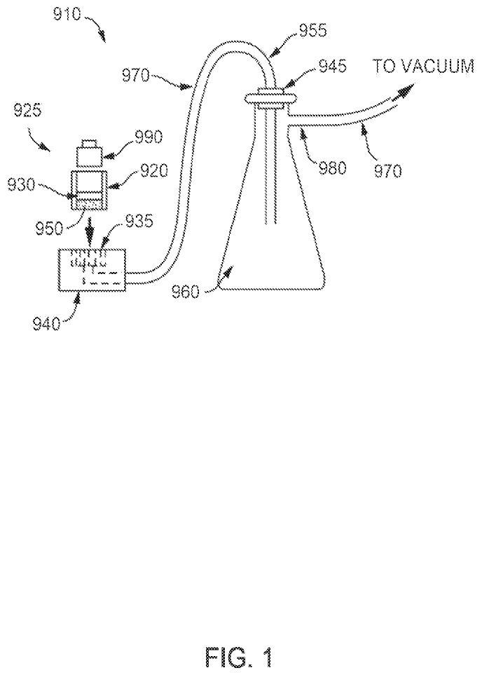

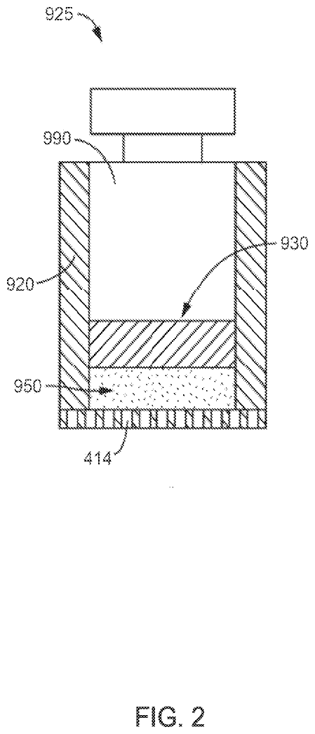

Referring to FIG. 1, for instance, one embodiment of an apparatus 910 that can be used to determine absorbent capacity is shown. The apparatus 910 includes an AUL assembly 925 having a cylinder 920, a piston 930 and weight 990. The weight 990 may be a 100-gram weight. A side arm flask 960 may be employed that is fitted with a rubber stopper 945 and tube 955 in the top of the flask to help trap any fluid removed from the sample before it enters the vacuum system. Rubber or plastic tubing 970 may be used to the side arm flask 960 and an AUL chamber 940. Additional tubing 970 may also be used to connect a vacuum source (not shown) and a side arm 980 of the flask 960. Referring to FIG. 2, the cylinder 920 may be used to contain superabsorbent material 950 and may be made from one-inch (2.54 cm) inside diameter acrylic tubing machined-out slightly to be sure of concentricity. After machining, a mesh cloth 414 (e.g., 400 mesh) may be attached to the bottom of the cylinder 920 using an appropriate solvent that causes the screen to be securely adhered to the cylinder. The piston 930 may be a 4.4-g piston made from 1-inch (2.5 cm) diameter solid material (e.g., acrylic) and may be machined to closely fit without binding in the cylinder 920. As noted above, the apparatus 910 also includes an AUL chamber 940 that removes interstitial liquid picked up during the swelling of the biodegradable superabsorbent material 950. This test apparatus is similar to a GATS (gravimetric absorbency test system), available from M/K Systems, as well as the system described by Lichstein at pages 129-142 of the INDA Technological Symposium Proceedings, March 1974. A ported disk 935 is also utilized having ports confined within a 2.5-centimeter diameter area.

To carry out the test, the following steps may be performed:
(1) Wipe the inside of the AUL cylinder 920 with an anti-static cloth, and weigh the cylinder 920, weight 990 and piston 930;
(2) Record the weight as CONTAINER WEIGHT in grams to the nearest milligram;
(3) Slowly pour the 0.16±0.005 gram sample of the biodegradable superabsorbent material 950 into the cylinder 920 so that the biodegradable superabsorbent material does not make contact with the sides of the cylinder or it may adhere to the walls of the AUL cylinder;
(4) Weigh the cylinder 920, weight 990, piston 930, and superabsorbent material 950 and record the value on the balance, as DRY WEIGHT in grams to the nearest milligram;
(5) Gently tap the AUL cylinder 920 until the biodegradable superabsorbent material 950 is evenly distributed on the bottom of the cylinder;
(6) Gently place the piston 930 and weight 990 into the cylinder 920;
(7) Place the test fluid (0.9 wt. % aqueous sodium chloride solution) in a fluid bath with a large mesh screen on the bottom;
(8) Simultaneously start the timer and place the biodegradable superabsorbent material 950 and cylinder assembly 925 onto the screen in the fluid bath. The level in the bath should be at a height to provide at least a 1 cm positive head above the base of the cylinder;
(9) Gently swirl the sample to release any trapped air and ensure the biodegradable superabsorbent material is in contact with the fluid.
(10) Remove the cylinder 920 from the fluid bath at a designated time interval and immediately place the cylinder on the vacuum apparatus (ported disk 935 on the top of the AUL chamber 940) and remove excess interstitial fluid for 10 seconds;
(11) Wipe the exterior of the cylinder with paper toweling or tissue;
(12) Weigh the AUL assembly (i.e., cylinder 920, piston 930 and weight 990), with the biodegradable superabsorbent material and any absorbed test fluid immediately and record the weight as WET WEIGHT in grams to the nearest milligram and the time interval; and
(13) Repeat for all time intervals needed.

At least two (2) samples are generally tested at each predetermined time interval. The time intervals are typically 15, 30, 60, 120, 300, 600, 1800 and 3600 seconds (or 0.015, 0.030, 0.060, 0.120, 0.300, 0.600, 1.8, or 3.6 kiloseconds). The “absorbent capacity” of the biodegradable superabsorbent material at a designated time interval is calculated in grams liquid by grams superabsorbent by the following formula:

(Wet Weight−Dry Weight)/(Dry Weight−Container Weight)

### Absorption Rate

The “Absorption Rate” of superabsorbent material can be determined at a designated time interval by dividing the Absorbent Capacity (g/g) described above by the specific time interval (kiloseconds, ks) of interest, such as 0.015, 0.030, 0.060, 0.120, 0.300, 0.600, 1.8, or 3.6 kiloseconds.

### Vortex Time

The Vortex Time is the amount of time in seconds required for a predetermined mass of superabsorbent material to close a vortex created by stirring 50 milliliters of 0.9 percent by weight sodium chloride solution at 600 revolutions per minute on a magnetic stir plate. The time it takes for the vortex to close is an indication of the free swell absorbing rate of the material. The vortex time test may be performed at a temperature is 23° C. and relative humidity of 50% according to the following procedure:
(1) Measure 50 milliliters (+0.01 milliliter) of 0.9 percent by weight sodium chloride solution into the 100-milliliter beaker.
(2) Place a 7.9 millimeters×32 millimeters TEFLON® covered magnetic stir bar without rings (such as that commercially available under the trade designation S/P® brand single pack round stirring bars with removable pivot ring) into the beaker.
(3) Program a magnetic stir plate (such as that commercially available under the trade designation DATAPLATE® Model #721) to 600 revolutions per minute.
(4) Place the beaker on the center of the magnetic stir plate such that the magnetic stir bar is activated. The bottom of the vortex should be near the top of the stir bar. The biodegradable superabsorbent material is pre-screened through a U.S. standard #30 mesh screen (0.595 millimeter openings) and retained on a U.S. standard #50 mesh screen (0.297 millimeter openings).
(5) Weigh out the required mass of the biodegradable superabsorbent material to be tested on weighing paper.
(6) While the sodium chloride solution is being stirred, quickly pour the biodegradable absorbent polymer to be tested into the saline solution and start a stopwatch. The biodegradable superabsorbent material to be tested should be added to the saline solution between the center of the vortex and the side of the beaker.
(7) Stop the stopwatch when the surface of the saline solution becomes flat and record the time. The time, recorded in seconds, is reported as the vortex time.

### Percent Moisture

To measure the percentage of moisture in the biodegradable superabsorbent material a moisture analyzer from A & D model MX50 was used. A heating temperature of 140° C. was used to determine percent moisture.

Quantification of Non-Solvent in SAM 0.03 grams of the SAM were placed into a 40 mL vial, into which 17 g of water was then added. The vial was then capped and placed on a wrist-action shaker for 30 minutes. The vial was then removed from the shaker and allowed to homogenize for 1 minute. 3 mL of the homogenized mixture was transferred to a syringe, and then filtered through a glass fiber/0.45 μm nylon membrane into a 2 mL GC autosampler vial, capturing 0.5 to 1 mL of filtrate. The filtrate was then analyzed by FC-FID methodology for non-solvent content.

### Analytical Method Conditions for Quantification of Non-Solvent

Instrument: Agilent 6890 GC
Column: DB-ALC1, 30 m×0.53 mm×3.0 μm film
Carrier Gas: Nitrogen
Injector: 0.5 μL @ 5:1 Split, Temp 250C
Detector: FID @ 300C
Temp Program: 40C for 3 min, 25C/min to 200C with 5 min hold
Run Time: 14.4 minutes
Retention Times: Methanol-1.8 min, Ethanol-2.4 min, IPA-2.9 min
Calibration for quantitation
Prepared standards containing methanol, ethanol, and isopropyl alcohol: 7 standards, 1-200 ppm, R2≥0.99.

### Determination of Surface to Volume Ratios

The method for determining the surface area to volume ratios (internal and external) includes the first step of acquiring digital x-ray Micro-CT images of a sample. These images are acquired using a SkyScan 1272 Micro-CT system available from Bruker microCT (2550 Kontich, Belgium). The sample is attached to a mounting apparatus, supplied by Bruker with the SkyScan 1272 system, so that it will not move under its own weight during the scanning process. The following SkyScan 1272 conditions were used during the scanning process:
Source Voltage (kV)=40
Source Current (uA)=200
Image Pixel Size (um)=1.0
Image Format=TIFF
Rotation Step (deg.)=0.1
Use 360 Rotation=NO
Frame Averaging=ON (6)
Random Movement=ON (1)
Flat Field Correction=ON
Filter=No Filter

After sample scanning is completed, the resulting X-ray image set is then reconstructed using the NRecon program provided with the SkyScan 1272 Micro-CT system. While reconstruction parameters can be somewhat sample dependent, and should be known to those skilled in the art, the following parameters should provide a basic guideline to an analyst:
Image File Type=JPG
Pixel Size (um)=1.0
Smoothing=1 (Gaussian)
Ring Artifact Correction=10
Beam Hardening Correction (%)=10

After reconstruction is completed, the resulting image data set is now ready for surface/volume ratio analysis using the Bruker SkyScan software package called CTAn, by downloading the entire reconstructed image data set into CTAn, and performing pre-analysis processing such as grayscale thresholding and despeckling, as known in the art. Finally, a shrink-wrap region of interest (ROI) is performed so that the biodegradable superabsorbent material is completely encased within the ROI. Now the 3D analysis can be selected and performed using the standard void volume and porosity parameters. When completed, the 3D results are available in a .txt file in the same folder that the reconstructed images slices reside.

In addition to surface/volume ratio analysis, the reconstructed image slices can also be analyzed using image analysis for their % internal voids and equivalent-circular diameter (ECD) pore size properties. The images for this analysis are binary images that are generated from the gray-scale images slices using the CTAn software after thresholding and despeckling have taken place.

The image analysis software platform used to perform the % voids and ECD measurements is a QWIN Pro (Version 3.5.1) or LAS (Version 4.13) available from Leica Microsystems, having an office in Heerbrugg, Switzerland.

For example, the method for determining the % voids and ECD pore size of a given sample includes the step of performing measurements on multiple image slices from the Micro-CT image set (e.g., every 100th image from a set of 2,500 images). Specifically, an image analysis algorithm is used to read and process images as well as perform measurements using Quantimet User Interactive Programming System (QUIPS) language. The image analysis algorithm is reproduced below.
NAME=Z-Void Volume & Pore Size (Micro-CT slices)
PURPOSE=Measures void volume and pore sizes of micro-CT cross-sections
CONDITIONS=Images acquired from 1272 SkyScan micro-CT
AUTHOR=D. G. Biggs
DATE=Oct. 12, 2020
DEFINE VARIABLES & OPEN FILES
Open File (C:\Data\00509-Qin\data.xls, channel #1)
PauseText (“Enter the number of the final image in the set.”)
Input (IMAGES)
SAMPLE ID AND SET UP
Enter Results Header
File Results Header (channel #1)
File Line (channel #1)
Measure frame (x 31, y 61, Width 3626, Height 3626)
Image frame (x 0, y 0, Width 3688, Height 3688)
   Calvalue 1.0 μm/pixel
CALVALUE=1.0
Calibrate (CALVALUE CALUNITS$ per pixel)
   Enter image prefix name of set of images to analyze
PauseText (“Enter image file prefix name.”)
Input (TITLE$)
File (“Rep. #”, channel #1)
File (“% Voids”, channel #1)
File Line (channel #1)
For (REPLICATE=1000 to IMAGES, step 100)
Clear Accepts
IMAGE ACQUISITION AND DETECTION
ACQOUTPUT=0
ACQFILE$=“C:\Images\00509-Qin\B-5 Bonnot Micro-CT Binaries\”+TITLE$+““+STR$(REPLICATE)+”.jpg”
Read image (from file ACQFILE$ into ACQOUTPUT)
Colour Transform (Mono Mode)
   Detect material
Detect (whiter than 32, from Image0 into Binary0)
Binary Amend (Close from Binary0 to Binary2, cycles 8, operator Disc, edge erode on)
Binary Amend (Close from Binary0 to Binary9, cycles 35, operator Disc, edge erode on)
Binary Amend (Open from Binary9 to Binary10, cycles 5, operator Disc, edge erode on)
   Detect Pores
Detect (blacker than 25, from Image0 into Binary1)
Binary Logical (C=A XOR B: C Binary3, A Binary10, B Binary2)
   Logical-Detect material & pores
IMAGE PROCESSING
MEASURE ANALYSIS REGIONS
   Total Structure Area-Material & Pores
MFLDIMAGE=10
Measure field (plane MFLDIMAGE, into FLDRESULTS(1), statistics into FLDSTATS(7,1))
   Selected parameters: Area
TOTSTRUCTAREA=FLDRESULTS(1)
   Pore Area
MFLDIMAGE=3
Measure field (plane MFLDIMAGE, into FLDRESULTS(1), statistics into FLDSTATS(7,1))
   Selected parameters: Area
POREAREA=FLDRESULTS(1)
PERCVOIDS=POREAREA/TOTSTRUCTAREA*100
   Measure pore size
Measure feature (plane Binary3, 8 ferets, minimum area: 24, grey image: Image0)
   Selected parameters: Area, X FCP, Y FCP, EquivDiam
Feature Histogram #1 (Y Param Number, X Param Area, from 10. to 1000000., logarithmic, 20 bins)
Feature Histogram #2 (Y Param Number, X Param EquivDiam, from 1. to 1000., logarithmic, 20 bins)
Display Feature Histogram Results (#1,horizontal, differential, bins+graph (Y axis linear), statistics)
   Data Window (1176, 206, 494, 360)
Display Feature Histogram Results (#2,horizontal, differential, bins+graph (Y axis linear), statistics)
   Data Window (1116, 593, 560, 360)
OUTPUT DATA
File (REPLICATE, channel #1, 0 digits after ‘.’)
File (PERCVOIDS, channel #1, 1 digit after ‘.’)
File Line (channel #1)
Next (REPLICATE)
File Line (channel #1)
File Line (channel #1)
File Line (channel #1)
File Feature Histogram Results (#1, differential, statistics, bin details, channel #1)
File Line (channel #1)
File Line (channel #1)
File Feature Histogram Results (#2, differential, statistics, bin details, channel #1)
Close File (channel #1)
END

The algorithm is executed using the Leica software. Once the algorithm has analyzed the designated images, results can be found in an EXCEL file located at the designated computer hard drive folder shown at the Open File line above.

### Materials

The following materials were used throughout the examples:
1. Glycerol, (>=99.5%) available from Sigma-Aldrich (St. Louis, MO), added as a latent crosslinker.

### Example 1

A superabsorbent material was formed from carboxymethyl cellulose (CMC) polymers having various molecular weights. Various amounts of the CMC polymers (as shown in Table 1) were mixed with specially formulated aqueous solutions comprising glycerol as a latent crosslinker with a goal to achieve final dried polymers all containing 3.4 wt. % of the glycerol crosslinking agent and a total solids as shown.

TABLE 1

| | CMC | | | Glycerol | Water | Crosslink | Solid |
|---|---|---|---|---|---|---|---|
| | Grade | CMC Mw | CMC | (g) | (mL) | % | wt. % |
| Sample 1 | Cekol 2000 | <500,000 | Na CMC | 12.5 | 500 | 3.4 | 20 |
| Sample 2 | Cekol 30000 | <500,000 | Na CMC | 12.5 | 500 | 3.4 | 20 |
| Sample 3 | CMC-7H | 700,000 | Na CMC | 25 | 500 | 3.4 | 40 |
| | Gum | | | | | | |
| Sample 4 | Walocel | 2,000,000 | Na CMC | 25 | 500 | 3.4 | 40 |
| | CRT 600000 | | | | | | |
| | GA07 | | | | | | |

*CMC: carboxymethyl cellulose

The CMC, glycerol, and water were fed into a twin-screw extruder, then, additional CMC powder was added as shown in Table 2:

| | 1^{st} | 2^{nd} | Solid | Solid | |
|---|---|---|---|---|---|
| | addition of | addition of | level | level | Drying |
| | dry CMC | dry CMC | after 1^{st} | after 2^{nd} | temp. |
| | (g) | (g) | addition | addition | (° C.) |
| Sample 1 | 40 | 40 | 40 | 60 | 100 |
| Sample 2 | 50 | 0 | 60 | 60 | 100 |
| Sample 3 | 20 | 15 | 50 | 55 | 100 |
| Sample 4 | 20 | 30 | 50 | 63.5 | 100 |

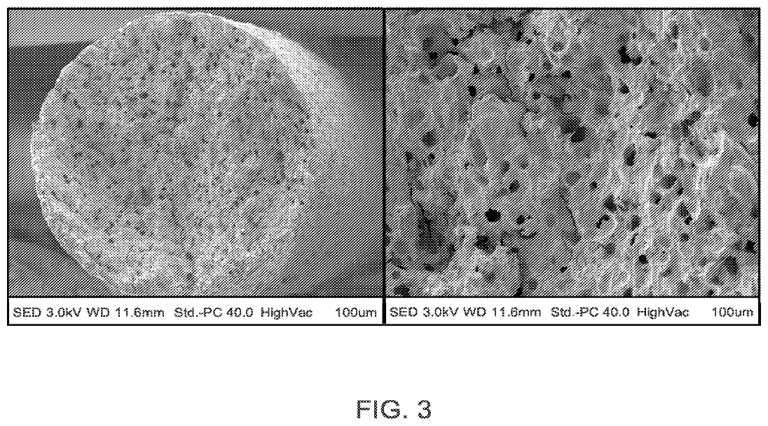

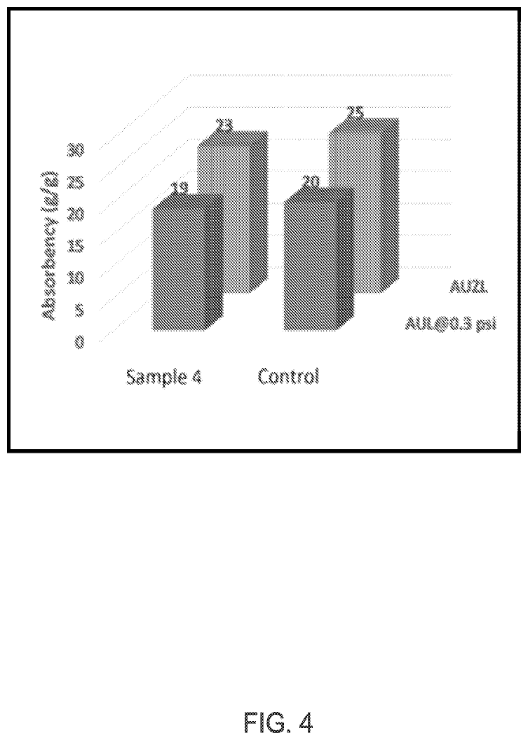

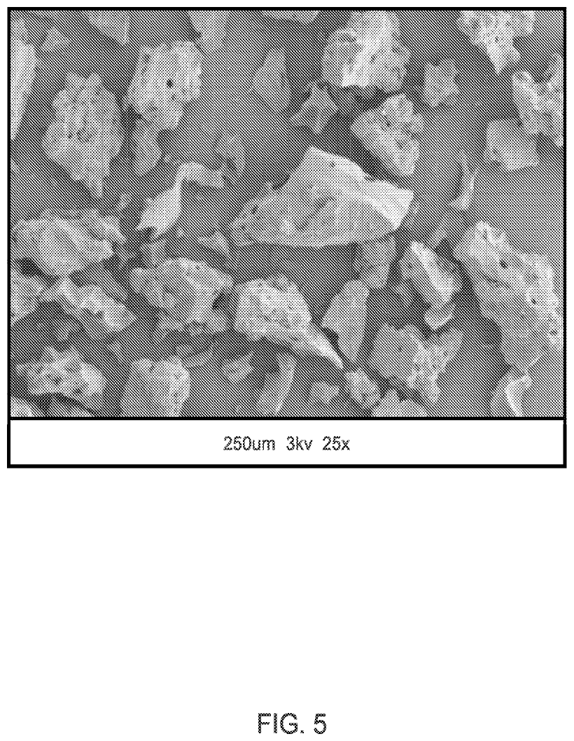

Each of the samples were extruded through a circular die at room temperature to form a superabsorbent material as discussed herein even at very high solid levels. Moreover, as illustrated by FIG. 3, which is an SEM photo of a cross-sectional of Sample 4, the superabsorbent materials exhibit a high level of porosity. In addition, referring to FIG. 4, Sample 4 was tested for absorbency under load (0.3 psi) and absorbency under zero load (AUZL), as compared to a commercially available CMC sample produced with a solids level of less than 5 wt. % (referred to as the “control” available as Aqualon CMC-7H4F containing 4 wt. % solids and formed from a CMC having a molecular weight of approximately 2,000,000). In addition, FIG. 5 shows an SEM photo of the control CMC. As illustrated in FIGS. 3-5, the biodegradable superabsorbent particles according to the present disclosure exhibited absorbency while exhibiting a highly microporous and lower density material than the control.

While the disclosure has been described in detail with respect to the specific aspects thereof, it will be appreciated that those skilled in the art, upon attaining an understanding of the foregoing, may readily conceive of alterations to, variations of, and equivalents to these embodiments. Accordingly, the scope of the present disclosure should be assessed as that of the appended claims and any equivalents thereto.

1. A method for forming a biodegradable superabsorbent material, the method comprising:
forming an aqueous polymer solution containing about 30 wt. % solids or greater, the aqueous polymer solution containing a linear water-soluble biodegradable polymer having a molecular weight of about 500,000 g/mol or greater and a non-reactive crosslinking agent;
extruding or pressing the polymer solution through an orifice;
drying the extruded or pressed polymer, and
curing the dried polymer at a temperature above a reaction temperature of the non-reactive crosslinking agent;
wherein, prior to the curing step, the temperature is maintained below the reaction temperature of the non-reactive crosslinking agent.

2. The method of claim 1, wherein at least a portion of the linear water-soluble biodegradable polymer is added to the aqueous polymer solution as a dry powder.

3. The method of claim 1, wherein the aqueous polymer solution contains about 40 wt. % solids or greater.

4. The method of claim 1, wherein the aqueous polymer solution contains about 50 wt. % solids or greater.

5. The method of claim 1, wherein the temperature is maintained at 100° C. or less prior to curing.

6. The method of claim 1, wherein the linear water-soluble biodegradable polymer has a molecular weight of about 1,000,000 g/mol or greater, preferably about 2,000,000 or greater.

7. The method of claim 1, wherein the linear water-soluble biodegradable polymer is a natural based modified polysaccharide polymer comprising at least one of a carboxymethyl cellulose, a carboxymethyl starch, an alginate, a chitosan salt, or combinations thereof.

8. The method of claim 1, wherein the linear water-soluble biodegradable polymer is a carboxyalkyl cellulose.

9. The method of claim 1, wherein the non-reactive crosslinking agent contains two or more functional groups capable of forming a covalent bond with at least one hydrophilic radical of the linear water-soluble biodegradable polymer, wherein the non-reactive crosslinking agent is glycerol, ammonium zirconium IV carbonate, or combinations thereof.

10. The method of claim 1, wherein the biodegradable superabsorbent material has a density of less than 1.6 g/cm³.

11. A biodegradable superabsorbent material formed from a linear water-soluble biodegradable polymer having a molecular weight of about 500,000 g/mol or greater and a non-reactive crosslinking agent,
wherein the biodegradable superabsorbent material contains a plurality of micropores having an average cross-sectional dimension of about 1 μm to about 200 μm.

12. A biodegradable superabsorbent material formed from a linear water-soluble biodegradable polymer having a molecular weight of about 500,000 g/mol or greater and a non-reactive crosslinking agent,
wherein the biodegradable superabsorbent material has a density of less than 1.6 g/cm³.

13. The biodegradable superabsorbent material of claim 11, wherein the linear water-soluble biodegradable polymer is a natural based modified polysaccharide polymer comprising at least one of a carboxymethyl cellulose, a carboxymethyl starch, an alginate, a chitosan salt, or combinations thereof.

14. The biodegradable superabsorbent material of claim 11, wherein the linear water-soluble biodegradable polymer is a carboxyalkyl cellulose.

15. The biodegradable superabsorbent material of claim 11, wherein the non-reactive crosslinking agent contains two or more functional groups capable of forming a covalent bond with at least one hydrophilic radical of the linear water-soluble biodegradable polymer, wherein the non-reactive crosslinking agent is glycerol, ammonium zirconium IV carbonate, or combinations thereof.

16. The biodegradable superabsorbent material of claim 11, wherein the biodegradable superabsorbent material exhibits an absorbency under load (0.3 psi) of about 15 g/g or greater.

17. The biodegradable superabsorbent material of claim 11, wherein the linear water-soluble biodegradable polymer has a molecular weight of about 1,000,000 g/mol or greater, wherein the linear water-soluble biodegradable polymer is a carboxymethyl cellulose.

18. The biodegradable superabsorbent material of claim 11, wherein the linear water-soluble biodegradable polymer has a molecular weight of about 2,000,000 g/mol or greater.

19. The biodegradable superabsorbent material of claim 11, wherein the biodegradable superabsorbent material has a percent porosity of at least about 5% or more.

20. The biodegradable superabsorbent material of claim 11, wherein the biodegradable superabsorbent material is extruded, optionally wherein the extruded material is cut into pellets after extrusion.
